(19) United States
(12) Patent Application Publication
(10) Pub. No.: US 2020/0381931 A1
(43) Pub. Date: Dec. 3, 2020

(54) WIRELESS CHARGING COIL WITH IMPROVED EFFICIENCY

(71) Applicant: Xtalic Corporation, Marlborough, MA (US)

(72) Inventors: Robert D. Hilty, Walpole, MA (US); Joshua Garth Abbott, Westborough, MA (US); Stephen Lucas, Port Charlotte, FL (US); John Cahalen, Arlington, MA (US); Alyssa Ann Kelley, Groveland, MA (US)

(73) Assignee: Xtalic Corporation, Marlborough, MA (US)

(21) Appl. No.: 16/510,130

(22) Filed: Jul. 12, 2019

Related U.S. Application Data
(60) Provisional application No. 62/855,813, filed on May 31, 2019.

(51) Int. Cl. H02J 7/00; H02J 7/02; H02J 50/10; H01F 1/34

(52) U.S. Cl. CPC H02J 7/0042; H01F 1/344; H02J 50/10; H02J 7/025

(57) ABSTRACT

Articles and methods for forming a layer of an iron oxide compound on a metal wire are generally described. The wire may be useful for wireless battery recharging devices.

### RELATED APPLICATIONS

This application claims priority to U.S. Provisional Application No. 62/855,813, filed May 31, 2019, which is incorporated herein by reference in its entirety.

### TECHNICAL FIELD

The present invention generally relates to articles and methods of forming a layer comprising an iron oxide compound on a metal wire. The use of the article as an inductive element in a wireless charging apparatus is also generally described.

### BACKGROUND

Wireless charging coils, such as those used for automotive charging and recharging of mobile phones, smartphones, laptops, and tablets, can provide quick and easy battery charging and recharging. However, these charging systems can have poor efficiency and slow charging times. Inductive coupling between the transmit and receive coils may be improved by modifying the magnetic characteristics of the wire used to fabricate these coils.

### SUMMARY

Articles and methods for fabricating a metal wire with a layer of an iron oxide compound with enhanced magnetic characteristics for inductive charging and/or wireless charging are generally described.

The subject matter of the present invention involves, in some cases, interrelated products, alternative solutions to a particular problem, and/or a plurality of different uses of one or more systems and/or articles.

In one aspect, an article is described, comprising a metal wire and a layer formed on the metal wire wherein the layer comprises an iron oxide compound.

In another aspect, a method of electrodepositing a layer on a metal wire is describe, where the layer comprises iron, and anodizing the layer such that at least a portion of the layer comprises an iron oxide compound.

Other advantages and novel features of the present invention will become apparent from the following detailed description of various non-limiting embodiments of the invention. In cases where the present specification and a document incorporated by reference include conflicting and/or inconsistent disclosure, the present specification shall control.

### DETAILED DESCRIPTION

Articles and methods for forming a layer of an iron oxide compound on metal wire are generally described. In certain embodiments, the metal wire with a layer of an iron oxide compound may function as a receive or transmit coil in a wireless battery charging apparatus. The wire may be coated with a layer of iron oxide compound, which may enhance the magnetic permeability of the wire to boost the efficiency of coupling of the transmit and receive coils. The metal(s) selected to be included with the iron in the iron oxide compound layer may be determined by determining a desired magnetic response of the coil to the frequency used in wireless charging. In some embodiments, the metal added to the iron oxide compound is nickel and/or zinc and may form an alloy. In some cases, the iron oxide compound layer comprises a metal oxide, which may be sufficiently electrically insulating to allow the elimination of a polymeric coating often applied to the surface of the wire as to reduce or eliminate electrical shorting between wraps of the wire in the coil. In some cases, the iron oxide layer may be cracked during the anodization process which may be beneficial in that it may disrupt electrical conductivity in the coating layer along the length of the wire.

Generally the invention describes an article or method of electrodepositing onto an article, the article, in some embodiments, comprising a metal wire and a layer comprising an iron oxide compound on the wire. In certain embodiments, the metal wire is a copper wire. In some embodiments, the metal wire may be repeatedly coiled as to be used for induction, e.g., as the inductive element in a wireless battery charging device. In some embodiments, the wire may be wound into a coil several times or many times (e.g. at least 10 times, at least 100 times, at least 1000 times, etc.). Those skilled in the art will be able to determine the number of winds in the coil in order to achieve appropriate inductive charging for a given use.

The metal wire used will be of the appropriate size to use within a device (e.g., in a wireless charging device). In some embodiments, the diameter of the metal wire is at least or equal to 50 μm, at least or equal to 60 μm, at least or equal to 70 μm, at least or equal to 80 μm, at least or equal to 90 μm, at least or equal to 100 μm, at least or equal to 110 μm, at least or equal to 120 μm, at least or equal to 130 μm, at least or equal to 140 μm, or at least or equal to 150 μm. In certain embodiments, the diameter of the metal wire is equal to or no more than 150 μm, equal to or no more than 140 μm, equal to or no more than 130 μm, equal to or no more than 120 μm, equal to or no more than 110 μm, equal to or no more than 100 μm, equal to or no more than 90 μm, equal to or no more than 80 μm, equal to or no more than 70 μm, equal to or no more than 60 μm, or equal to or no more than 50 μm. The metal wire may have a diameter of any size, as the disclosure is not so limited.

Certain embodiments may have a layer formed on metal wire. In some cases, there may be intervening layers between the metal wire and the layer formed on the metal wire. In some embodiments, the layer formed on the metal wire is a metal oxide. In some embodiments, the layer formed is an iron oxide compound. In some embodiments, the layer formed comprises ferrite. As described herein, “ferrite” refers to oxides of the form (FeₓM₁₋ₓ)₃O₄, where M is a metal. In some embodiments, the metal is selected from the group consisting of Co, Cu, Mg, Mn, Ni, and Zn and x is equal to or between 0 and 0.5. In certain embodiments, the metal M is absent, such that the composition of the ferrite layer is Fe₃O₄. In some embodiments, an iron oxide compound has at least one of several FeₓO_{y} configurations, where x is equal to or between 1-13 and y is equal to or between 0-50. Other configurations of metal, iron, and oxygen may be possible.

The layered formed on the metal wire may comprise an alloy according to certain embodiments. In some cases, the alloy is formed by an electrodeposition process. In some embodiments, the alloy may comprise iron, nickel, zinc, or combinations thereof. In some embodiments, the alloy is a binary alloy comprising two distinct metals. In some embodiments, the alloy is a ternary alloy, comprising three distinct metals. As a non-limiting example, a ternary alloy comprising iron, nickel, and zinc may be synthesized using electrodeposition or otherwise formed by a process. Other combinations of metals are possible.

A metal layer formed on the metal, in some embodiments may undergo an anodization or oxidation process in order to form an iron oxide compound, as described further below. For example, iron may be electrodeposited on the metal wire and anodized into an iron oxide compound. In some cases, the article may include one or more additional layer(s) (e.g., metal, metal alloy, metal oxide layer(s), etc.) between the layer comprising an iron oxide compound and the metal wire and/or above the layer comprising an iron oxide compound. In some cases, only a portion thereof of the layer may be anodized.

In certain embodiments the layer formed on the metal wire may have a nanocrystalline microstructure. As used herein, a “nanocrystalline” structure refers to a structure in which the number-average size of crystalline grains is less than one micron. The number-average size of the crystalline grains provides equal statistical weight to each grain and is calculated as the sum of all spherical equivalent grain diameters divided by the total number of grains in a representative volume of the body. Without wishing to be bound by theory, layers formed with a nanocrystalline microstructures may comprise nanoscale grains that provide improved magnetic properties and/or improved wireless charging. Some embodiments may have a layered formed with an amorphous structure. As known in the art, an amorphous structure is a non-crystalline structure characterized by having no long range symmetry in the atomic positions. Examples of amorphous structures include glass, or glass-like structures.

Certain embodiments may comprise an oxide layer. In some cases, the oxide layer is nanocrystalline. In some cases, the oxide layer is amorphous. In certain embodiments, the oxide (e.g., metal oxide) layer has a desired grain size and/or a grain size that may be controlled when the layer is formed. The grain size may be nanocrystalline or amorphous and may result in beneficial magnetic properties. The structure of the oxide layer, in some embodiments, may be related to the structure of the deposited layer or the deposited alloy.

The iron oxide layer may coat the wire in a way that helps capture the transmitted energy in a wireless charging apparatus before it propagates past the receive coil. In some cases, the iron oxide layer may be sufficiently electrically insulating to allow the elimination of a polymeric coating often applied to the top surface of wires used for inductive charging as a way to reduce electrical shorting between wraps of the coiled wire. In some embodiments, the iron oxide layer is cracked during the anodization process, which may be advantageous in that it disrupts electrical conductivity in the coating layer along the length of the wire.

In some cases, a polymeric layer may coat the surface of the metal wire or the metal oxide layer (e.g. iron oxide layer). In some embodiments, the polymeric layer is on the surface of the iron oxide layer formed on the metal wire. The polymeric layer may prevent the wire from electrically contacting itself when coiled. In certain embodiments, there is no polymeric layer present on the surface of the metal wire, and instead, the iron oxide layer may serve the function of the polymeric layer in preventing electrical contact between the coils of the wire.

Electrodeposition may be used to form a layer or layers onto a wire in some embodiments. Electrodeposition generally involves the deposition of a material (e.g., electroplate) on a substrate (e.g. a metal wire as a substrate) by contacting the substrate with an electrodeposition bath and flowing electrical current between two electrodes through the electrodeposition bath, i.e., due to a difference in electrical potential between the two electrodes. For example, methods described herein may involve providing an anode, a cathode, an electrodeposition bath (also known as an electrodeposition fluid) associated with (e.g., in contact with) the anode and cathode, and a power supply connected to the anode and cathode. In some cases, the power supply may be driven to generate a waveform for producing a layer, as described more fully below.

Generally, a layer may be applied using separate electrodeposition baths. In some cases, individual articles may be connected such that they can be sequentially exposed to separate electrodeposition baths, for example in a reel-to-reel process. For instance, articles may be connected to a common conductive substrate (e.g., a strip). In some embodiments, each of the electrodeposition baths may be associated with separate anodes and the interconnected individual articles may be commonly connected to a cathode.

A variety of electrochemical baths may be used for electrodeposition process. In certain embodiments an electrochemical bath contains at least an iron ionic species. The oxidation state of the iron ionic species may be 2, 3, or any other oxidation state available to iron in its compounds. In certain embodiments, other metals may be present. Those metals may be selected from the group consisting of cobalt, copper, magnesium, manganese, nickel, and zinc. Other metals may be suitable. In general, metal salts of Fe, Co, Cu, Mg, Mn, Ni, or Zn may be used as the sources of the metallic species. For example, these salts may be metal chlorides (e.g. FeCl₃), metal bromides, metal sulfates, metal nitrates, metal phosphates. Other metal salts or molecular species may be suitable as the disclosure is not so limited. Those of ordinary skill in the art will be able to determine other appropriate metal salt for electrodeposition.

Certain embodiments use an electrodeposition bath that may contain at least one component that does not contain a metal species, but may further aid in the electrodeposition process. Non-limiting examples of these components include citric acid (and salts thereof), tartaric acid (and salts thereof), acetic acid (and salts thereof), formic acid (and salts thereof), oxalic acid (and salts thereof), boric acid, saccharin, sodium chloride, sodium bromide, ammonium chloride, aluminum sulfate (or a hydrate thereof), alkali phosphates (e.g. Na₃PO₄), and non-ionic surfactants. These components may be useful in complexing metal species in solution, adjusting or buffering the pH of the electrodeposition bath, or other useful purposes. In some embodiments, other ligands or complexing agents may be present. In some embodiments, stress-reducing compounds may comprise the electrodeposition bath. In certain embodiments, a buffering agent may further comprise the electrodeposition bath. In certain embodiments, conducting salts may further comprise the electrodeposition bath. Other components may comprise the bath depending on the desired composition of the ferrite layer or the metal oxide layer.

In some cases, the electrodeposition bath may further comprise a component that controls the pH, for example, to control the formation of iron hydroxides or Fe³⁺ in the electrodeposition bath or in resulting articles. Broadly, the pH may be maintained between 2-5. In some cases, the pH is kept below 7 to discourage formation of Fe(III). In some embodiments, the pH is kept below 3.5 in order to discourage iron hydroxide formation.

Certain embodiments of the invention may involve an anodization process of a metal wire. In some embodiments, this anodization process happens using non-aqueous conditions. Electrodeposition baths for anodization may comprise ethylene glycol and ammonium fluoride. In some cases, a low concentration of water may be present even with non-aqueous conditions due to the hygroscopy of the ammonium fluoride and/or ethylene glycol. For non-aqueous anodization, a temperature of or between 20-30° C. may be used, a voltage between 20-50V may be applied, and a post-conversion annealing process may occur after anodization at a temperature at or between 400-700° C. for anywhere between 5-60 minutes. For aqueous anodization, a bath may comprise 0.5-1.5 M NaOH or KOH. For aqueous anodization, a temperature of or between 20-40° C. may be used, a current density of 5-20 mA/cm² may be applied, and a post-conversion annealing process may occur after anodization at a temperature at or between 400-700° C. for anywhere between 5-60 minutes.

The electrodeposition process(es) may be modulated by varying the potential that is applied between the electrodes (e.g., potential control or voltage control), or by varying the current or current density that is allowed to flow (e.g., current or current density control). In some embodiments, the layer may be formed (e.g., electrodeposited) using direct current (DC) plating, pulsed current plating, reverse pulse current plating, or combinations thereof. In some embodiments, reverse pulse plating may be preferred, for example, to form the barrier layer (e.g., nickel-tungsten alloy). Pulses, oscillations, and/or other variations in voltage, potential, current, and/or current density, may also be incorporated during the electrodeposition process, as described more fully below. For example, pulses of controlled voltage may be alternated with pulses of controlled current or current density. In general, during an electrodeposition process an electrical potential may exist on the substrate (e.g., base material) to be coated, and changes in applied voltage, current, or current density may result in changes to the electrical potential on the substrate. In some cases, the electrodeposition process may include the use waveforms comprising one or more segments, wherein each segment involves a particular set of electrodeposition conditions (e.g., current density, current duration, electrodeposition bath temperature, etc.), as described more fully below.

Some embodiments involve electrodeposition methods wherein the grain size of electrodeposited materials (e.g., metals, alloys, and the like) may be controlled. In some embodiments, selection of a particular coating (e.g., electroplate) composition, such as the composition of an alloy deposit, may provide a coating having a desired grain size. In some embodiments, electrodeposition methods (e.g., electrodeposition conditions) described herein may be selected to produce a particular composition, thereby controlling the grain size of the deposited material.

In some embodiments, a coating, or portion thereof, may be electrodeposited using direct current (DC) plating. For example, a substrate (e.g., electrode) may be positioned in contact with (e.g., immersed within) an electrodeposition bath comprising one or more species to be deposited on the substrate. A constant, steady electrical current may be passed through the electrodeposition bath to produce a coating, or portion thereof, on the substrate. In some embodiments, the potential that is applied between the electrodes (e.g., potential control or voltage control) and/or the current or current density that is allowed to flow (e.g., current or current density control) may be varied. For example, pulses, oscillations, and/or other variations in voltage, potential, current, and/or current density, may be incorporated during the electrodeposition process. In some embodiments, pulses of controlled voltage may be alternated with pulses of controlled current or current density. In some embodiments, the coating may be formed (e.g., electrodeposited) using pulsed current electrodeposition, reverse pulse current electrodeposition, or combinations thereof.

In some cases, a bipolar waveform may be used, comprising at least one forward pulse and at least one reverse pulse, i.e., a “reverse pulse sequence.” In some embodiments, the at least one reverse pulse immediately follows the at least one forward pulse. In some embodiments, the at least one forward pulse immediately follows the at least one reverse pulse. In some cases, the bipolar waveform includes multiple forward pulses and reverse pulses. Some embodiments may include a bipolar waveform comprising multiple forward pulses and reverse pulses, each pulse having a specific current density and duration. In some cases, the use of a reverse pulse sequence may allow for modulation of composition and/or grain size of the coating that is produced.

Articles described herein, such as a wire with an electrodeposited coating of an iron oxide compound, may be used as for wireless charging devices. As described herein, wireless charging (or inductive charging, used interchangeable herein) uses an electromagnetic field to transfer energy between two objects through electromagnetic induction. This is accomplished using a receive and transmit apparatus. The transmit apparatus is typically stationary and remains plugged into a standard wall outlet contains a transmit coil. The receiving apparatus is typically the device whose battery is to be recharged (e.g. cell phone, smartphone, tablet, laptop, etc.) and contains a receiving coil. Energy is sent through an inductive coupling to an electrical device (i.e. from the transmit coil to the receive coil), which can then use that energy to charge batteries or run the device. Inductive charging uses an induction coil (i.e. transmit coil) to create an alternating electromagnetic field from within a charging base, and a second induction coil (receive coil) in the portable device receives power from the electromagnetic field and converts it back into electric current to charge the battery. The two induction coils in proximity combine to form an electrical transformer. Greater distances between sender and receiver coils can be achieved when the inductive charging system uses resonant inductive coupling.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An article, comprising:
a metal wire; and
a layer formed on the metal wire, the layer comprising an iron oxide compound.

2. An article of claim 1, wherein the layer formed on the metal comprises at least a metal selected from the group consisting of nickel and zinc.

3. An article of claim 1, wherein the layer further comprises one or more of a metal selected from the group consisting of cobalt, copper, magnesium, and manganese.

4. An article of claim 1, wherein the an iron oxide compound is of the form (FeₓM₁₋ₓ)₃O₄, where M is any metal selected from the group consisting of Co, Cu, Mg, Mn, Ni, and Zn and x is equal to or between 0 and 0.5.

5. An article of claim 1, wherein the article further comprises a polymeric coating on the layer.

6. An article of claim 1, wherein an oxide coat is present on a surface of the layer.

7. An article of claim 1, wherein the an iron oxide compound is at least partially cracked.

8. An article of claim 1, wherein the article is configured as a coil of a wireless charging apparatus.

9. An article of claim 1, wherein the metal wire has a core with a diameter equal to or between 50 μm and 150 μm.

10. An article of claim 1, wherein the metal wire is coated by an iron oxide material with a thickness equal to or between 0.5 μm and 5 μm.

11. An article of claim 1, wherein the layer comprising the iron oxide compound is nanocrystalline and/or amorphous.

12. An article of claim 1, wherein the layer comprises ferrite.

13. A method, comprising:
electrodepositing a layer on a metal wire, wherein the layer comprises iron; and
anodizing at least a portion of the layer to form an iron oxide compound.

14. The method of claim 13, wherein the an iron oxide compound further comprises one or more of a metal selected from the group consisting of cobalt, copper, magnesium, manganese, nickel, and zinc.

15. The method of claim 13, an iron oxide compound is of the form (FexM1-x)3O4, where M is any metal selected from the group consisting of Co, Cu, Mg, Mn, Ni, and Zn and x is equal to or between 0 and 0.5.

16. The method of claim 13, wherein a polymeric coating is applied on the layer.

17. The method of claim 13, wherein an oxide coat is present on a surface of the layer.

18. The method of claim 13, wherein the layer is at least partially cracked after anodization.

19. The method of claim 13, wherein the metal wire comprising the layer is configured as a coil of a wireless charging apparatus.

20. The method of claim 13, wherein the metal wire has a core with a diameter equal to or between 50 μm and 150 μm.

21. The method of claim 13, wherein the layer is nanocrystalline and/or amorphous.
